(19) United States
(12) Patent Application Publication
(10) Pub. No.: US 2020/0365032 A1
(43) Pub. Date: Nov. 19, 2020

(54) SYSTEM AND METHOD OF ALERTING ROAD USERS TO SAFE STOPPING DISTANCE

(71) Applicants: Mark Peter SCHWARZ, Queensland (AU); Julie-Ann Fay Le NOBLE, Queensland (AU)

(72) Inventors: Mark Peter SCHWARZ, Queensland (AU); Julie-Ann Fay Le NOBLE, Queensland (AU)

(21) Appl. No.: 16/967,190

(22) PCT Filed: Feb. 5, 2019
(86) PCT No.: PCT/AU2019/050083

§ 371 Date: Aug. 4, 2020

(30) Foreign Application Priority Data
Feb. 5, 2018 (AU) 2018900349

(51) Int. Cl. G08G 1/16; G07C 5/08; H04N 5/225; G06K 9/00

(52) U.S. Cl. CPC G08G 1/166; G07C 5/085; G06K 9/00825; H04N 5/2253; G08G 1/162

(57) ABSTRACT

An alert system for monitoring at least one incursion into a safe stopping distance of a primary vehicle, the alert system including at least one forward facing sensor mounted relative to the primary vehicle to capture data, at least one image capture device mounted relative to the primary vehicle, at least one alert device associated with the primary vehicle, and a calculation engine to calculate a minimum safe stopping distance for the primary vehicle based on a real time speed of the vehicle and a vehicle weight, and to calculate a separation distance to a third party vehicle to be calculated relative to the primary vehicle based on the data captured by the at least one forward facing sensor, wherein the calculation engine compares the minimum safe stopping distance at any time to the separation distance to the third party vehicle to establish if the third party vehicle is within the minimum safe stopping distance of the primary vehicle, and if the third party vehicle is within the minimum safe stopping distance for the primary vehicle, capturing at least one real-time image of the at least one incursion using the at least one image capture device and logging the at least one incursion in a log.

### TECHNICAL FIELD

The present invention relates to a system and method of alerting road users to safe stopping distance particularly a system and method allowing a heavy vehicle to alert other vehicle of an encroachment on the minimum safe stopping distance of the heavy vehicle.

### BACKGROUND ART

There is an increasing number of road users on Australia's roads, and those drivers are of an increasing diversity.

Private cars, heavy haulage, construction traffic, now all commonly share the same space. Many private vehicle users do not understand the physics involved in driving a prime mover and grossly underestimate the stopping distance of these trucks. Many assume that a truck can stop in the same space that a small car can, and do not allow adequate space or courtesy to the drivers of these heavy vehicles. Additional to this they do not understand the impact of a full load on the braking distance of a vehicle. It is not easy to see from the outside of a covered truck if it is empty of at full GMV.

Many accidents involving trucks and cars are due to a vehicle pulling in front of a heavy truck, compromising their safe stopping distance. If an accident occurs at this point, it is commonly assumed that the vehicle that failed to pull up in time is at fault, despite the actions of the other road user.

The key characteristics of heavy freight vehicle drivers (n=291) involved in fatal crashes within Queensland, 1 Jan. 2006 to 31 Dec. 2010, were:
242 (or 84.0%) were going straight ahead;
64 fatalities (or 21.4%) were heavy freight vehicle drivers,
10 fatalities (or 3.3%) were passengers of heavy freight vehicles; and
225 fatalities (or 75.3%) were other road users (drivers, riders, passengers, pedestrians or bicyclists).

Road transport in Australia is big business, but it suffers the same pressures as many other competitive industries including increased pressure to cut costs, to work longer hours mean that many haulage businesses are feeling financial pressure.

An accident has numerous impacts, including:
Loss of life
Loss of Equipment
Loss of Earning Potential
Physical and Psychological Damage
A dramatic increase in insurance premium.
   All of these elements add even greater pressure on a small business.

It will be clearly understood that, if a prior art publication is referred to herein, this reference does not constitute an admission that the publication forms part of the common general knowledge in the art in Australia or in any other country.

### SUMMARY OF INVENTION

The present invention is directed to a system and method of alerting road users to safe stopping distance, which may at least partially overcome at least one of the abovementioned disadvantages or provide the consumer with a useful or commercial choice.

With the foregoing in view, the present invention in one form, resides broadly in an alert system for monitoring at least one incursion into a safe stopping distance of a primary vehicle, the alert system including
1. At least one forward facing sensor mounted relative to the primary vehicle to capture data,
2. At least one image capture device mounted relative to the primary vehicle,
3. At least one alert device associated with the primary vehicle, and
4. A calculation engine to calculate a minimum safe stopping distance for the primary vehicle based on a real time speed of the vehicle and a vehicle weight, and to calculate a separation distance to a third party vehicle to be calculated relative to the primary vehicle based on the data captured by the at least one forward facing sensor
Wherein the calculation engine compares the minimum safe stopping distance at any time to the separation distance to the third party vehicle to establish if the third party vehicle is within the minimum safe stopping distance of the primary vehicle, and if the third party vehicle is within the minimum safe stopping distance for the primary vehicle;
   a. Capturing at least one real-time image of the at least one incursion using the at least one image capture device; and
   b. Logging the at least one incursion in a log.

In another form, the present invention resides in an alert system for alerting road users to safe stopping distance of a primary vehicle having an onboard weighing system, the alert system including
1. At least one forward facing sensor mounted relative to the primary vehicle to capture data,
2. At least one image capture device mounted relative to the primary vehicle, and
3. At least one alert device mounted to the primary vehicle mounted to the vehicle in a forward direction, and
4. A calculation engine to calculate a minimum safe stopping distance for the primary vehicle based on a real time speed of the vehicle and a vehicle weight, and to calculate a separation distance to a third party vehicle to be calculated relative to the primary vehicle based on the data captured by the at least one forward facing sensor
Wherein the calculation engine compares the minimum safe stopping distance at any time to the separation distance to the third party vehicle to establish if the third party vehicle is within the minimum safe stopping distance of the primary vehicle, and if the third party vehicle is within the minimum safe stopping distance for the primary vehicle;
   a. Actuating the at least one alert device to alert at least one driver of the third party vehicle that they are within the minimum safe stopping distance for the primary vehicle,
   b. Capturing at least one real-time image of the unsafe driving manoeuvre using the at least one image capture device, and
   c. Logging an unsafe driving manoeuvre in a log.

The system may include the step of alerting at least a driver of the primary vehicle of the unsafe driving manoeuvre or incursion at the same time as sub-steps a. to c. occur. Importantly, once an incursion or unsafe driving manoeuvre has been detected, a number of actions preferably take place at the same time including alerting the at least one alert device, capturing the real-time image of the unsafe driving manoeuvre (or extracting it from a real-time feed) and the formation of an electronic log file including information pertinent to the incursion, including time prior to the incursion being detected and a reasonable or predetermined time afterwards.

The system of the present invention includes at least one image capture device, normally in the form of a camera in order to record any incursions or unsafe driving manoeuvres which do occur. The camera may be operating in the record mode at all times when the vehicle ignition is on or alternatively, the recording may be triggered by the detection of an incursion. If the former, then the camera will typically be powered by the vehicle power supply and once the ignition is turned on, the camera will typically start recording.

It is preferred that any image capture device or camera used in the system of the present invention is forward facing although more than one camera may be provided directed in different directions (including forward facing) as this may allow the capture of more or more detailed information.

In a particularly preferred embodiment, the at least one image capture device or camera will typically be a part of an in-cab device provided in the driving cabin of the primary vehicle. An in-cab device will typically be mounted within the cab so as not to obscure vision for the driver of the primary vehicle but will typically also allow the driver to easily view the in-cab device. More than one in-cab device may be provided. At least one in-cab device may be provided to allow information and/or feedback to be displayed for the use of the driver. At least one in-cab device may be provided which includes both the at least one forward facing sensor and at least one image capture device. The calculation engine may be provided in association with one or more of the in-cab devices.

In a particularly preferred embodiment, the at least one forward facing sensor and at least one image capture device will preferably be combined with the calculation engine in a single unit. In this way, information can be provided between the forward facing sensor, the image capture unit and the calculation engine to allow actuation and/or control of the camera function by the at least one forward facing sensor and/or the calculation engine and/or allow the calculation of the parameters with less lag for more immediate action. Provision of a single in-cab unit incorporating both the at least one forward facing sensor and the at least one image capture the device together with the calculation engine will also allow information to be processed more quickly without requiring information to be forwarded to remote units for calculation and/or action.

At least one of the components of the system of the present invention, and preferably an in-cab device, may be associated with a GPS receiver in order to provide real time location information in relation to the primary vehicle. In some preferred embodiments, the GPS receiver could be used to calculate the speed of the vehicle as well as providing location data for the logging of incursions when they occur.

The system of the present invention is directed towards providing an alert system for third party vehicles when they enter the minimum safe stopping distance of a primary vehicle. Typically, one or more components are mounted on or relative to a primary vehicle in order to provide an alert not only to other, third-party vehicles but also to the driver of the primary vehicle, preferably automatically and without the driver of the primary vehicle having to take any action. Upon an incursion taking place, the system of the present invention will preferably capture salient information in relation to the incursion and log this information, preferably in an electronic log which may be on board the vehicle and/or maintained remotely. Typically, the salient information will include the time of the incursion, the date of the incursion, the location of the incursion and typically, at least one image captured by at least one image capture device, preferably video, of the incursion. Typically, the salient information and normally the at least one image will capture identifying characteristics or identifying information relating to the third party vehicle causing the incursion. This information may be used in any way but for example, if an accident occurs, may be tendered as evidence of fault. Preferably, the electronic log will not be accessible by the driver of the vehicle at any time and incursion events will be logged in the electronic log without requiring any action from the driver of the primary vehicle.

Although the primary vehicle may be of any type, the primary vehicle will normally be a heavy vehicle for example a truck or similar as it is these types of vehicles which suffer the most from third-party vehicles impeding on the minimum safe stopping distance.

The present invention includes at least one forward facing sensor mounted relative to the primary vehicle to capture data.

Any kind of sensor may be used provided that the sensor can capture data that can be used to calculate a separation distance between the primary vehicle and the third-party vehicle. For example, the sensor may use lidar, radar, sonar or a binocular computer vision system may be provided. The system of the present invention may use more than one system for calculating the separation distance and the particular system for calculating the separation distance may differ dependent upon conditions (and may swapping between the different systems automatically). For example, the system may use lidar for separation distance calculation during daylight hours and/or in fine weather and use radar for cloudy weather and/or night-time calculation when lidar is less effective.

The at least one forward facing sensor may be mounted anywhere on the vehicle but will typically be mounted on a forward portion of the vehicle. As mentioned previously, the at least one forward facing sensor may form part of an in-cab device which may be mounted on the vehicle dashboard for example. Alternatively, the at least one forward facing sensor can be mounted on another portion of the vehicle such as within a grill or grate or relative to a vehicle bumper for example.

More than one forward facing sensor may be provided. More than one sensor may be provided and in some configurations, at least one sensor may be provided oriented to the sides of the vehicle in order to measure the distance between the primary vehicle and vehicles on one or both sides.

The at least one forward facing sensor will preferably capture data in order to send this data to the calculation engine in order to calculate separation distance. The least one forward facing sensor will typically operate when the vehicle is running and may preferably be connected to the vehicle ignition. It is preferred that the at least one forward facing sensor will be powered by the vehicle power supply.

The present invention includes at least one image capture device mounted relative to the primary vehicle. As mentioned above, the at least one image capture device will typically be or include a camera and a video or moving picture capture device is preferred although a device which captures one or more still images may be used.

Typically, a single image capture device is provided and as mentioned above, in some preferred embodiments, the image capture device may be provided in the same unit as the at least one forward facing sensor, particularly for retrofit applications.

The at least one image capture device may be associated with the forward facing sensor and/or the calculation engine in order to be actuated automatically when an incursion is detected based on the data captured by the sensor and/or calculated by the calculation engine.

In a preferred embodiment, the at least one image capture device may operate at all times when the vehicle is running. In a particularly preferred embodiment, the calculation engine and/or control mechanism provided in relation to the system will preferably have the ability to extract or log a particular portion of the data or feed captured by the at least one image capture device upon the occurrence of an incursion in order to log that portion in relation to the incursion rather than simply log all of the data collected. Normally once an incursion is detected, the portion of the feed which is logged includes a portion from before the incursion. In other words, the feed is captured continuously but only a particular portion of the feed, including a historical portion, is logged. The historical portion may be a predefined time portion extending backwards from the incursion, once the incursion is detected.

Any type of camera may be provided but it is preferred that a digital camera is provided with the at least one image captured by the preferred digital camera sent straight to electronic storage. Preferably, electronic storage will be provided to capture at least one image in relation to each incursion.

In a preferred form, the calculation engine and/or control mechanism provided will preferably log a portion of the captured at least one image wherein the log portion will typically be extracted automatically out of a real-time feed based on the time of the incursion. For example, the preferred digital video camera will preferably operate at all times when the vehicle is running. When an incursion is detected, the calculation engine and/or control mechanism will typically log a portion of the captured real-time feed surrounding the actual time of incursion. In other words, once an incursion is detected, the control mechanism will preferably log a portion of the video feed which is historical from the actual time of the incursion in order to capture the lead up to the incursion as well is the incursion itself and what occurs after the incursion. Normally, a particular time period will be set and the control mechanism will normally log the particular time period prior to the incursion based on the particular real-time point of incursion. In this way, the system can minimise the amount of information which is actually logged rather than logging the entire video feed.

The present invention also includes at least one alert device associated with the primary vehicle. Any type of alert device may be provided and a number of alert devices may be provided. Although a visual alert device is preferred, the system of the present invention may include at least one audio alert device as well or instead of at least one visual or other device.

In a preferred embodiment, the visual alert device will preferably include at least one light, and preferably, an elongate light bar or similar Normally, the visual alert device will be provided at a forward portion of the vehicle and facing forwardly so that a vehicle in front of the primary vehicle can be alerted and the driver of the third-party vehicle will typically notice the alert in their rearview mirrors. Preferably, the visual alert device will be sufficiently bright to be recognised as an alert during daylight hours. Preferably, the visual alert device will be capable of alerting third-party drivers in colour, and a red alert device is particularly preferred. Text may or may not be used in relation to the alert device so that a third-party driver who is being alerted can read a message in the alert. If text is provided, the text will typically be indicated in the reverse format so as to be viewable and readable in a third-party vehicle rearview mirror. In a particularly preferred form, a light bar is used, the light bar formed from a series of LEDs which are capable of being lit together to form a sufficiently bright visual alert even in daylight.

Where an audio alert device is used, it is preferred that the audio alert is sufficiently loud to be heard but this could be distracting which is why audio alerts are less preferred to visual alerts. Where an audio alert is used, normally an alarm tone or similar will be used.

The at least one alert device will typically be in communication with the calculation engine and/or control mechanism in order to be actuated by the control c\mechanism based on the comparison undertaken by the calculation engine. This may be achieved by either hardwiring the at least one alert device to the control mechanism but a wireless communication link could be used.

The present invention includes a calculation engine to calculate a minimum safe stopping distance for the primary vehicle based on a real time speed of the vehicle and a vehicle weight, and to calculate a separation distance to a third party vehicle to be calculated relative to the primary vehicle based on the data captured by the at least one forward facing sensor.

The calculation engine will typically be or include a software application operating on processing hardware which will receive input/captured data from components of the system such as the at least one sensor and use that input/captured data to calculate parameters such as the minimum safe stopping distance and one or more separation distances for comparison according to invention. Normally, the calculation engine will calculate the parameters in real time.

The minimum safe stopping distance for example will normally be calculated based on the speed of the vehicle and the weight of the vehicle. The weight of the vehicle may be gained from an on-board electronic weighing system for example or alternatively, may be manually input by the driver of the primary vehicle and/or a load master once the vehicle has been loaded. The speed of the vehicle may be provided by the vehicle itself (such as from the speed measuring system of the vehicle) or alternatively, a location system which operates in real time may be used to calculate the speed of the vehicle using second by second location data for example.

The function of the calculation engine is to determine when an incursion of a third-party vehicle into the minimum safe stopping distance forwardly of the primary vehicle occurs. The calculation engine will typically use the data captured from the at least one sensor to calculate and instantaneous separation distance to a third-party vehicle in front of the primary vehicle. The calculation engine will then compare this separation distance to the calculated minimum safe stopping distance. Depending upon the output of the comparison, action will be taken to alert the driver of the third-party vehicle and log an incursion if an incursion has been deemed to have taken place, OR, if the separation distance is greater than the minimum safe stopping distance, the no action will be taken. It is to be appreciated that incursions will normally occur when a third-party vehicle changes lanes in front of the primary vehicle and/or the primary vehicle approaches a third-party vehicle from the rear.

When an incursion takes place, the calculation engine will typically create an electronic file containing information sale and to the details and nature of the incursion. For example, the electronic file will normally include a portion of, preferably real time video including a portion from before the incursion has taken place in order to see the lead up to the incursion as well as the time, the date, the speed of the primary vehicle, the weight of the primary vehicle, the minimum safe stopping distance and the distance to the third-party vehicle. Normally, this information may be created and overlaid on the real-time video which is logged.

The electronic file which is logged may be logged on board the vehicle, preferably in an electronic log and an electronic log entry may be forwarded to a remote location or server via a communications link which is provided in association with the system of the present invention. The communication link will preferably be a wireless communication link and the upload of the electronic incursion log file will typically take place automatically once the electronic log file has been created. This will typically allow monitoring from a remote location such as fleet operations where there are a variety of vehicles in a particular fleet or to an insurer or law-enforcement for example.

As mentioned previously, it is preferred that an in-cab device incorporating at least one forward facing sensor and at least one image capture device as well as the calculation engine and control mechanism will be provided in a single unit having hardware components and software components provided on board. Information may be processed remotely from the primary vehicle but preferably, the information and calculations will be conducted on board the primary vehicle in order to minimise any lag involved.

According to particular aspects of the present invention, two configurations may be preferred, namely a first configuration in which an in-cab device including at least one forward facing sensor and at least one image capture device as well as the calculation engine in control mechanism will be provided in association with at least one visual alert device located on a forward portion of the vehicle and an in-cab display (which may be a part of the in-cab device or separate therefrom) in order to provide information and feedback to the driver of the primary vehicle or a second configuration in which an in-cab device including at least one forward facing sensor and at least one image capture device as well as the calculation engine and control mechanism will be provided in association with application software operating on a personal computing device such as a smart phone or tablet or the like with wireless communication between the in-cab device and the personal computing device to allow information to be transferred from the in-cab device to the personal computing device and vice versa. Normally, a first configuration is a more advanced model and will normally be used for business use where a business owns or operates more than one vehicle and the second configuration will typically be directed towards more personal use such as individual vehicle owners, for example.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is an overhead schematic view of a dangerous driving manoeuvre by a third party vehicle or car relative to an articulated primary vehicle or truck.

FIG. 2 is a schematic side view f a safe stopping distance of a fully laden truck

FIG. 3 is a schematic side view of the safe stopping distance of an empty truck.

FIG. 4 is a schematic isometric view of one form of operation of the system of the present invention occurring when a vehicle moves into a lane in front of a truck

FIG. 5 is a schematic view of an alert issued to the third party vehicle if the minimum safe stopping distance is of the primary vehicle is entered according to a preferred embodiment of the present invention.

FIG. 6 is a schematic view of an alert issued to the driver of the primary vehicle upon occurrence of an unsafe driving manoeuvre according to a preferred embodiment of the present invention.

FIG. 7 is a schematic view of a remote reporting functionality according to a preferred embodiment of the present invention.

FIG. 8 is a flow diagram of use of the system according to a preferred embodiment of the present invention.

FIG. 9 is a view of the components of a corporate package provided to each vehicle in a fleet of vehicles according to a preferred embodiment of the present invention.

FIG. 10 is a view of the components of a corporate package provided to retail customer according to a preferred embodiment of the present invention.

### DESCRIPTION OF EMBODIMENTS

According to preferred embodiments of the present invention, a system of alerting road users to safe stopping distance is provided.

The system is directed toward solving the issue that arises in the scenario illustrated in FIG. 1. As illustrated, a truck 10 is travelling along a road at a given speed and a third party vehicle 11 changes lanes directly in front of the truck 10, not appreciating that the truck 10 requires a considerable distance to stop safely and changing lanes in front of the truck 10 can place the third party vehicle 11 in an extremely dangerous situation if an incident should occur that requires the truck to stop

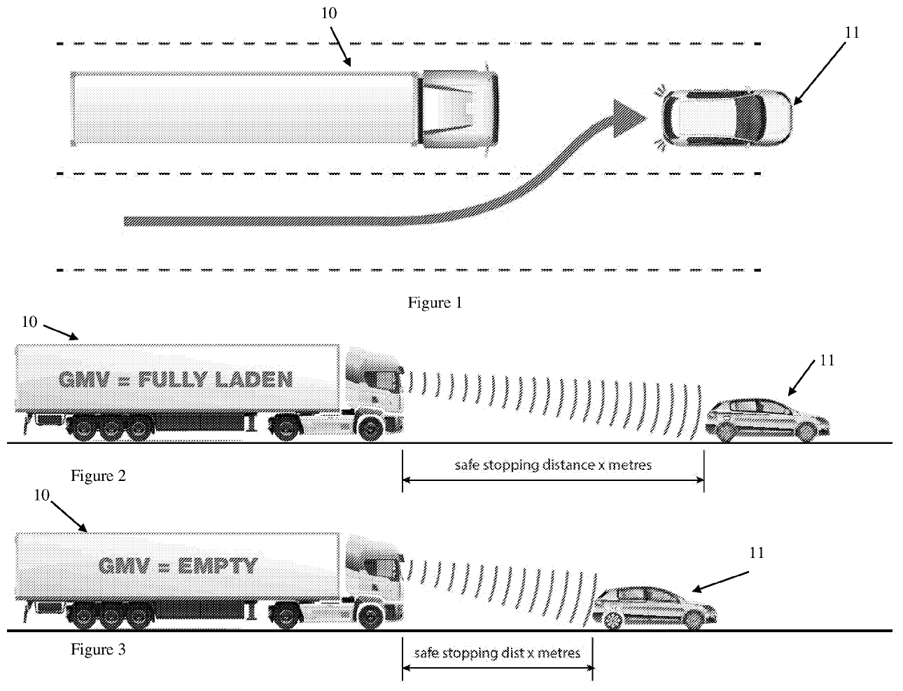

As shown in FIG. 2, the minimum safe stopping distance for a laden vehicle is greater than the minimum safe stopping distance for an unladen vehicle, shown in FIG. 3, and the minimum safe stopping distance will generally depend not only on the weight of the vehicle including any load but also the speed at which the vehicle is travelling at any moment when the driver has to apply the brakes to stop the vehicle.

The system of the preferred embodiment is includes at least one forward facing sensor mounted relative to the primary vehicle to capture data, at least one image capture device mounted relative to the primary vehicle, at least one alert device associated with the primary vehicle, and a calculation engine to calculate a minimum safe stopping distance for the primary vehicle based on a real time speed of the vehicle and a vehicle weight, and to calculate a separation distance to a third party vehicle to be calculated relative to the primary vehicle based on the data captured by the at least one forward facing sensor.

The calculation engine compares the minimum safe stopping distance at any time to the separation distance to the third party vehicle to establish if the third party vehicle is within the minimum safe stopping distance of the primary vehicle, and if the third party vehicle is within the minimum safe stopping distance for the primary vehicle, the at least one alert device is actuated to alert at least one driver of the third party vehicle that they are within the minimum safe stopping distance for the primary vehicle (one example of this is illustrated in FIG. 5), the at least one image capture device captures at least one real-time image of the incursion and incursion event is logged in a log including salient information pertaining to the incursion and including the at least one real-time image of the incursion. All of these steps typically occur substantially at the same time and may be referred to collectively as the incursion reaction.

The system may include the step of alerting at least a driver of the primary vehicle of the unsafe driving manoeuvre or incursion at the same time as the incursion reaction takes place, one example of which is illustrated in FIG. 6.

Importantly, once an incursion has been detected, a number of actions preferably take place at the same time including alerting the at least one alert device, capturing the real-time image of the unsafe driving manoeuvre (or extracting it from a real-time feed) and the formation of an electronic log file including information pertinent to the incursion, including time prior to the incursion being detected and a reasonable or predetermined time afterwards.

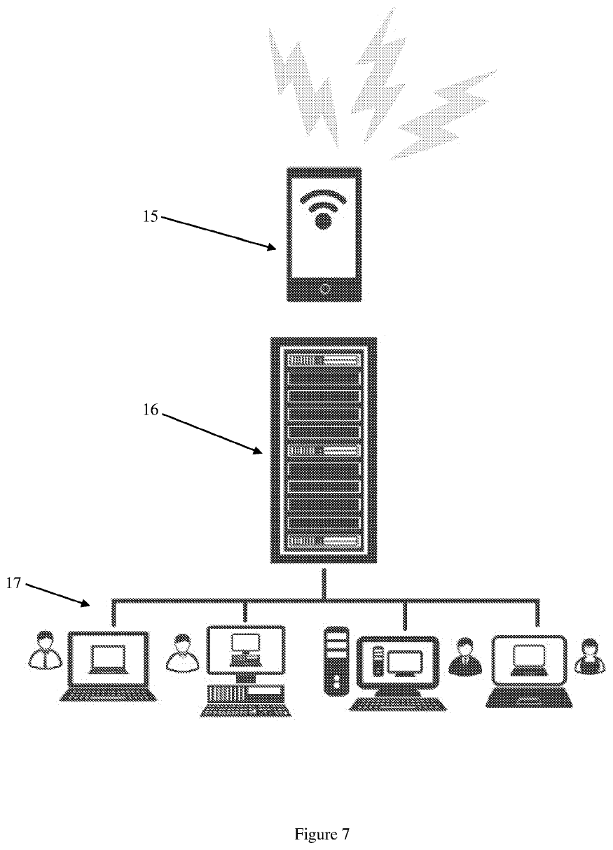

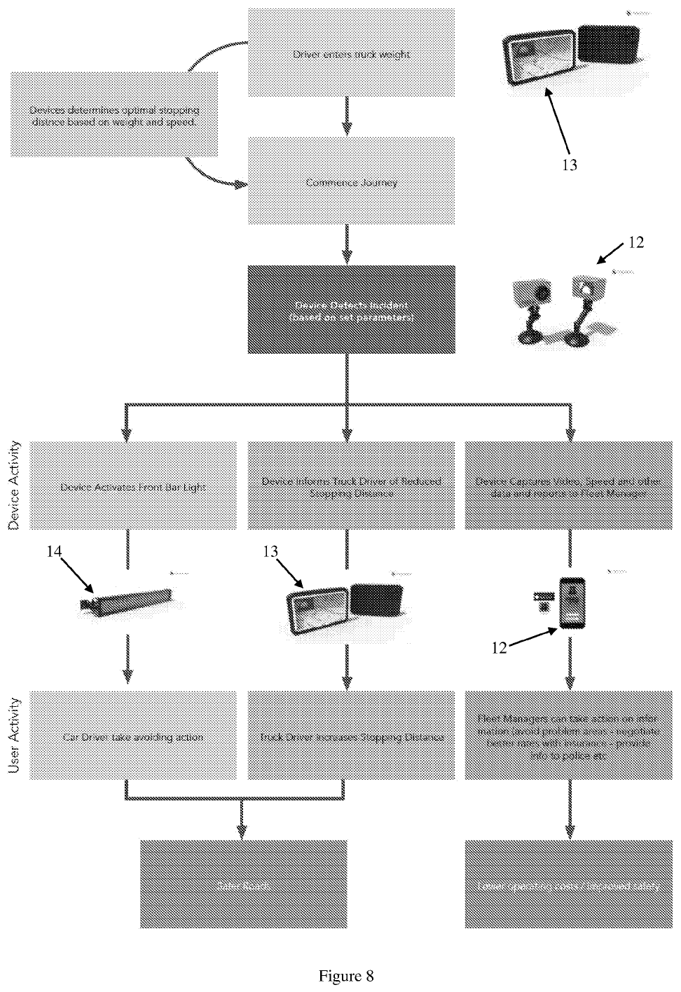

The hardware of the preferred embodiment is illustrated in FIGS. 7, 9 and 10. The at least one image capture device is normally provided in the form of a camera in order to record any incursions or unsafe driving manoeuvres which do occur. The camera may be operating in the record mode at all times when the vehicle ignition is on or alternatively, the recording may be triggered by the detection of an incursion. If the former, then the camera will typically be powered by the vehicle power supply and once the ignition is turned on, the camera will typically start recording.

It is preferred that any image capture device or camera used in the system of the present invention is forward facing although more than one camera may be provided directed in different directions (including forward facing) as this may allow the capture of more or more detailed information.

In the particularly preferred embodiment illustrated, the camera is a part of an in-cab device 12 provided in the driving cabin of the primary vehicle 10. This in-cab device 12 is preferably mounted within the cab so as not to obscure vision for the driver of the primary vehicle 10 but will typically also allow the driver to easily view the in-cab device 12. The in-cab device 12 shown in the Figures includes a camera, a sensor and a rear display.

More than one in-cab device may be provided an in particular a second in-cab device 13 may be provided to allow information and/or feedback to be displayed for the use of the driver, such as that shown in FIG. 6 (although this functionality may be included in in-cab device 12).

The at least one forward facing sensor and camera will preferably be combined with the calculation engine in a single unit 12. In this way, information can be provided between the forward facing sensor, the camera and the calculation engine to allow actuation and/or control of the camera function by the at least one forward facing sensor and/or the calculation engine and/or allow the calculation of the parameters with less lag for more immediate action. Provision of a single in-cab unit 12 incorporating both the at least one forward facing sensor and the at least one image capture the device together with the calculation engine will also allow information to be processed more quickly without requiring information to be forwarded to remote units for calculation and/or action.

The system of the present invention is directed towards providing an alert system for third party vehicles 11 when they enter the minimum safe stopping distance of a primary vehicle 10. Typically, one or more components are mounted on or relative to a primary vehicle 10 in order to provide an alert not only to other, third-party vehicles 11 but also to the driver of the primary vehicle 10, preferably automatically and without the driver of the primary vehicle 10 having to take any action. Upon an incursion taking place, the system of the present invention will preferably capture salient information in relation to the incursion and log this information, preferably in an electronic log which may be on board the vehicle 10 and/or maintained remotely. Typically, the salient information will include the time of the incursion, the date of the incursion, the location of the incursion and typically, a portion of a real time captured video feed captured by the camera of the incursion. Typically, the salient information including the portion of real time captured video feed will capture identifying characteristics or identifying information relating to the third party vehicle 11 causing the incursion. This information may be used in any way but for example, if an accident occurs, may be tendered as evidence of fault. Preferably, the electronic log will not be accessible by the driver of the vehicle 10 at any time and incursion events will be logged in the electronic log without requiring any action from the driver of the primary vehicle 10.

Although the primary vehicle may be of any type, the primary vehicle will normally be a heavy vehicle for example a truck or similar as it is these types of vehicles which suffer the most from third-party vehicles impeding on the minimum safe stopping distance.

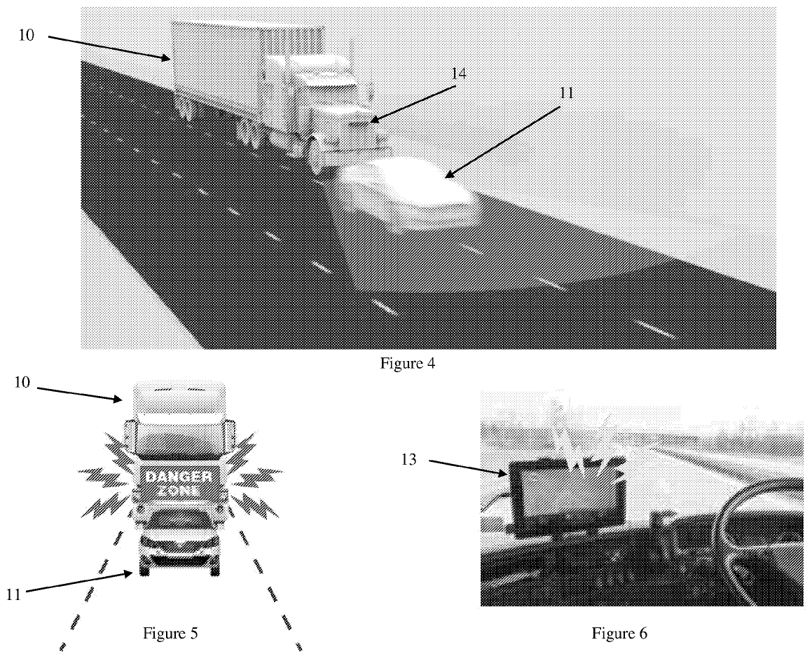

Any kind of sensor may be used provided that the sensor can capture data that can be used to calculate a separation distance between the primary vehicle 10 and the third-party vehicle 11. For example, the sensor may use lidar, radar, sonar or a binocular computer vision system may be provided. The system of the present invention may use more than one system for calculating the separation distance and the particular system for calculating the separation distance may differ dependent upon conditions (and may swapping between the different systems automatically). For example, the system may use lidar for separation distance calculation during daylight hours and/or in fine weather and use radar for cloudy weather and/or night-time calculation when lidar is less effective. The sensor will preferably be directed forwardly and normally in a forwardly oriented arc such as that shown in FIG. 4.

The forward facing sensor may be mounted anywhere on the vehicle 10 but will typically be mounted on a forward portion of the vehicle 10. As mentioned previously, the sensor may form part of an in-cab device 12 which may be mounted on the vehicle dashboard for example.

The sensor will preferably capture data in order to send this data to the calculation engine in order to calculate separation distance. The sensor will typically operate when the vehicle is running and is normally connected to the vehicle ignition to be powered by the vehicle power supply.

Typically, a single camera is provided and as mentioned above, in some preferred embodiments, the camera may be provided in the same unit 12 as the sensor, particularly for retrofit applications.

In the preferred embodiment, the camera will operate at all times when the vehicle 10 is running. In a particularly preferred embodiment, the calculation engine and/or control mechanism provided in relation to the system has the ability to extract or log a particular portion of the data or feed captured by the camera upon the occurrence of an incursion in order to log that portion in relation to the incursion rather than simply log all of the data collected. Normally once an incursion is detected, the portion of the feed which is logged includes a portion from before the incursion. In other words, the feed is captured continuously but only a particular portion of the feed, including a historical portion, is logged once an incursion is detected. The historical portion may be a predefined time portion extending backwards from the incursion, once the incursion is detected. In other words, once an incursion is detected, the control mechanism will preferably log a portion of the video feed which is historical from the actual time of the incursion in order to capture the lead up to the incursion as well is the incursion itself and what occurs after the incursion. Normally, a particular time period will be set and the control mechanism will normally log the particular time period prior to the incursion based on the particular real-time point of incursion. In this way, the system can minimise the amount of information which is actually logged rather than logging the entire video feed.

Any type of camera may be provided but it is preferred that a digital camera is provided with the real time feed captured by the preferred digital camera sent straight to electronic storage. The electronic storage can be retained or deleted once the vehicle has stopped to reduce storage issues.

Any type of alert device may be provided and a number of alert devices may be provided.

According to the preferred embodiment, a visual alert device in the form of an elongate light bar 14 is provided at a forward portion of the vehicle 10 and facing forwardly so that a vehicle 11 in front of the primary vehicle 10 can be alerted and the driver of the third-party vehicle 11 will notice the alert in their rearview mirrors. Preferably, the elongate light bar 14 is sufficiently bright to be recognised as an alert during daylight hours. Preferably, the elongate light bar 14 will be capable of alerting third-party drivers in colour, and a red alert device is particularly preferred. Text (such as that illustrated in FIG. 5) may or may not be used in relation to the alert device so that a third-party driver who is being alerted can read a message in the alert. If text is provided, the text will typically be indicated in the reverse format so as to be viewable and readable in a third-party vehicle rearview mirror. In a particularly preferred form, a light bar is used, the light bar formed from a series of LEDs which are capable of being lit together to form a sufficiently bright visual alert even in daylight.

The alert device will typically be in communication with the calculation engine and/or control mechanism in order to be actuated by the control mechanism based on the comparison undertaken by the calculation engine. This may be achieved by either hardwiring the elongate light bar 14 to the control mechanism but a wireless communication link could be used.

The calculation engine will typically be or include a software application operating on processing hardware which will receive input/captured data from components of the system such as the at least one sensor and use that input/captured data to calculate parameters such as the minimum safe stopping distance and one or more separation distances for comparison according to invention. Normally, the calculation engine will calculate the parameters in real time.

The minimum safe stopping distance for example will normally be calculated based on the speed of the vehicle 10 and the weight of the vehicle 10. The weight of the vehicle 10 may be gained from an on-board electronic weighing system for example or alternatively, may be manually input by the driver of the primary vehicle 10 and/or a load master once the vehicle has been loaded. The speed of the vehicle 10 may be provided by the vehicle itself (such as from the speed measuring system of the vehicle) or alternatively, a location system which operates in real time may be used to calculate the speed of the vehicle using second by second location data for example.

The function of the calculation engine is to determine when an incursion of a third-party vehicle 11 into the minimum safe stopping distance forwardly of the primary vehicle occurs. The calculation engine will typically use the data captured from the at least one sensor to calculate and instantaneous separation distance to a third-party vehicle in front of the primary vehicle. The calculation engine will then compare this separation distance to the calculated minimum safe stopping distance. Depending upon the output of the comparison, action will be taken to alert the driver of the third-party vehicle and log an incursion if an incursion has been deemed to have taken place, OR, if the separation distance is greater than the minimum safe stopping distance, the no action will be taken. It is to be appreciated that incursions will normally occur when a third-party vehicle 11 changes lanes in front of the primary vehicle 10 and/or the primary vehicle 10 approaches a third-party vehicle 11 from the rear.

When an incursion takes place, the calculation engine will typically create an electronic file containing information sale and to the details and nature of the incursion. For example, the electronic file will normally include a portion of, preferably real time video including a portion from before the incursion has taken place in order to see the lead up to the incursion as well as the time, the date, the speed of the primary vehicle 10, the weight of the primary vehicle 10, the minimum safe stopping distance and the distance to the third-party vehicle 10. Normally, this information may be created and overlaid on the real-time video which is logged.

The electronic file which is logged may be logged on board the vehicle, preferably in an electronic log and an electronic log entry may be forwarded to a remote location or server via a communications link which is provided in association with the system of the present invention. The communication link will preferably be a wireless communication link and the upload of the electronic incursion log file will typically take place automatically once the electronic log file has been created. This will typically allow monitoring from a remote location such as fleet operations where there are a variety of vehicles in a particular fleet or to an insurer or law-enforcement for example.

As mentioned previously, it is preferred that an in-cab device 12 incorporating the sensor and the camera as well as the calculation engine and control mechanism will be provided in a single unit having hardware components and software components provided on board. Information may be processed remotely from the primary vehicle but preferably, the information and calculations will be conducted on board the primary vehicle 10 in order to minimise any lag involved. Once an incursion has been detected, the on board device 12, 13 or 15 may transmit the incursion report to a remotely located server 16 via a wireless communication platform in order that the incursion report be provided to interested users who may include insurers, law enforcement, and management 17.

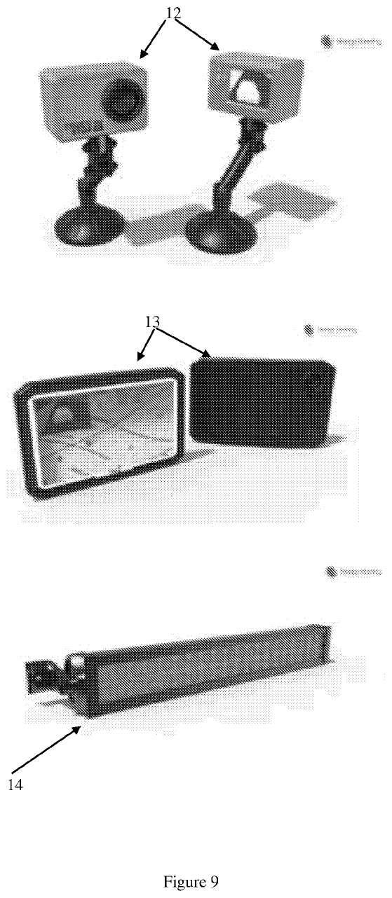

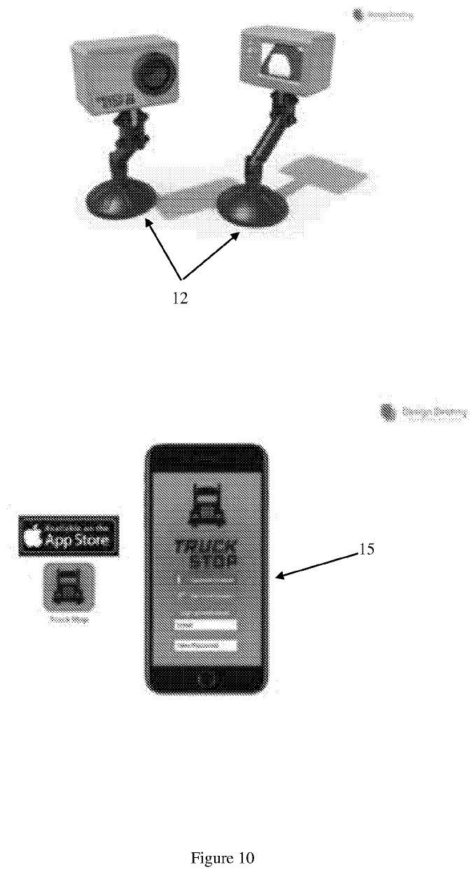

According to particular aspects of the present invention, two configurations may be preferred, namely a first configuration illustrated in FIG. 9 in which an in-cab device 12 including the sensor and camera as well as the calculation engine and control mechanism is provided in association with an elongate light bar 14 located on a forward portion of the vehicle 10 and a secondary in-cab display 13 (which may be a part of the in-cab device or separate therefrom) in order to provide information and feedback to the driver of the primary vehicle 10 and a second configuration illustrated in FIG. 10, in which an in-cab device 12 including the sensor and camera as well as the calculation engine and control mechanism is provided in association with application software operating on a personal computing device 15 such as a smart phone or tablet or the like with wireless communication between the in-cab device 12 and the personal computing device 15 to allow information to be transferred from the in cab device 12 to the personal computing device 15 and vice versa. Normally, a first configuration is a more advanced model and will normally be used where a business owns or operates more than one vehicle and the second configuration will typically be directed towards more personal use such as individual vehicle owners, for example.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An alert system for monitoring at least one incursion into a safe stopping distance of a primary vehicle, the alert system including
a) At least one forward facing sensor mounted relative to the primary vehicle to capture data,
b) At least one image capture device mounted relative to the primary vehicle,
c) At least one alert device associated with the primary vehicle, and
d) A calculation engine to calculate a minimum safe stopping distance for the primary vehicle based on a real time speed of the vehicle and a vehicle weight, and to calculate a separation distance to a third party vehicle to be calculated relative to the primary vehicle based on the data captured by the at least one forward facing sensor
Wherein the calculation engine compares the minimum safe stopping distance at any time to the separation distance to the third party vehicle to establish if the third party vehicle is within the minimum safe stopping distance of the primary vehicle, and if the third party vehicle is within the minimum safe stopping distance for the primary vehicle, identifying at least one incursion event;
1) Capturing at least one real-time image of the at least one incursion event using the at least one image capture device; and
2) Logging the at least one incursion event in a log.

2. An alert system for alerting road users to safe stopping distance of a primary vehicle having an onboard weighing system, the alert system including
a) At least one forward facing sensor mounted relative to the primary vehicle to capture data,
b) At least one image capture device mounted relative to the primary vehicle, and
c) At least one alert device mounted to the primary vehicle mounted to the vehicle in at least a forward direction, and
d) A calculation engine to calculate a minimum safe stopping distance for the primary vehicle based on a real time speed of the vehicle and a vehicle weight, and to calculate a separation distance to a third party vehicle to be calculated relative to the primary vehicle based on the data captured by the at least one forward facing sensor
Wherein the calculation engine compares the minimum safe stopping distance at any time to the separation distance to the third party vehicle to establish if the third party vehicle is within the minimum safe stopping distance of the primary vehicle, and if the third party vehicle is within the minimum safe stopping distance for the primary vehicle, identifying an unsafe driving manoeuvre;
1) Actuating the at least one alert device to alert at least one driver of the third party vehicle that they are within the minimum safe stopping distance for the primary vehicle,
2) Capturing at least one real-time image of the unsafe driving manoeuvre using the at least one image capture device, and
3) Logging an unsafe driving manoeuvre in a log.

3. An alert system as claimed in claim 2 further including the step of alerting at least a driver of the primary vehicle of the unsafe driving manoeuvre or incursion concurrently within identification of the unsafe driving manoeuvre or incursion.

4. An alert system as claimed in claim 2 wherein the logging step includes formation of an electronic log file including information pertinent to the unsafe driving manoeuvre or incursion, including time prior to the unsafe driving manoeuvre or incursion being detected and a reasonable or predetermined time afterwards.

5. An alert system as claimed in claim 2 wherein the at least one image capture device, includes at least one camera to capture real-time video footage.

6. An alert system as claimed in claim 5 wherein the at least one camera operates in a record mode at all times when the vehicle ignition is on.

7. An alert system as claimed in claim 5 wherein the at least one camera operates in a record mode triggered by the detection of an unsafe driving manoeuvre or incursion.

8. An alert system as claimed in claim 2 wherein the at least one image capture device is a part of an in-cab device provided in a driving cabin of the primary vehicle.

9. An alert system as claimed in claim 8 wherein the in-cab device includes the at least one forward facing sensor.

10. An alert system as claimed in claim 2 wherein a single in-cab unit incorporating the at least one forward facing sensor, the at least one image capture device and the calculation engine.

11. An alert system as claimed in claim 2 further including a GPS receiver in order to provide real time location information in relation to the primary vehicle.

12. An alert system as claimed in claim 11 wherein the GPS receiver is used to calculate the speed of the primary vehicle as well.

13. An alert system as claimed in claim 2 wherein more than one sensor is provided, at least one sensor provided oriented to the sides of the primary vehicle in order to measure the distance between the primary vehicle and one or more vehicles on one or both sides of the primary vehicle.

14. An alert system as claimed in claim 2 wherein the at least one alert device includes at least one light to provide a visual alert.

15. An alert system as claimed in claim 14 wherein the at least one alert device is provided at a forward portion of the primary vehicle and facing forwardly so that a third-party vehicle in front of the primary vehicle can be alerted.

16. An alert system as claimed in claim 2 wherein the calculation engine includes a software application operating on processing hardware to receive input/captured data from the at least one sensor to calculate one or more separation distances for comparison in real time and speed information from the primary vehicle to calculate minimum safe stopping distance.

17. An alert system as claimed in claim 2 wherein the minimum safe stopping distance is calculated based on the speed of the primary vehicle and weight of the primary vehicle gained from an on-board electronic weighing system in real time.

18. An alert system as claimed in claim 2 wherein the logging step includes creation of an electronic file containing information regarding the unsafe driving manoeuvre or incursion and is logged on board the primary vehicle in an electronic log.

19. An alert system as claimed in claim 2 wherein the logging step includes creation of an electronic file containing information regarding the unsafe driving manoeuvre or incursion and an electronic log entry is forwarded to a remote location or server via a communications link.

20. An alert system as claimed in claim 2 wherein two units are provided, an in-cab device incorporating the at least one forward facing sensor and at least one image capture device as well as the calculation engine and control mechanism and the at least one alert device as a second unit operably connected to the in-cab unit.

21. An alert system as claimed in claim 2 in a first configuration in which an in-cab device including at least one forward facing sensor and at least one image capture device as well as the calculation engine and control mechanism is provided in association with at least one visual alert device located on a forward portion of the vehicle and an in-cab display in order to provide information and feedback to the driver of the primary vehicle.

22. An alert system as claimed in claim 2 in a second configuration in which an in-cab device including at least one forward facing sensor and at least one image capture device as well as the calculation engine and control mechanism is provided in association with application software operating on a personal computing device with wireless communication between the in-cab device and the personal computing device to allow information to be transferred between the in-cab device and the personal computing device.
